(19) United States
(12) Patent Application Publication
(10) Pub. No.: US 2024/0134931 A1
(43) Pub. Date: Apr. 25, 2024

(54) MATRIX COMPUTING DEVICE AND OPERATION METHOD THEREOF

(71) Applicant: NEUCHIPS CORPORATION, Hsinchu City (TW)

(72) Inventors: Chiung-Liang Lin, Taichung City (TW); YuShan Ruan, New Taipei City (TW); Huan Jan Chou, Taipei City (TW)

(73) Assignee: NEUCHIPS CORPORATION, Hsinchu City (TW)

(21) Appl. No.: 18/076,407

(22) Filed: Dec. 7, 2022

(30) Foreign Application Priority Data
Oct. 19, 2022 (TW) 111139781

(51) Int. Cl. G06F 17/16; G06F 7/50; G06F 7/523; G06F 7/544; G06F 7/78

(52) U.S. Cl. CPC G06F 17/16; G06F 7/50; G06F 7/523; G06F 7/5443; G06F 7/78

(57) ABSTRACT

A matrix computing device and an operation method for the matrix computing device are provided. The matrix computing device includes a storage unit, a control circuit, and a computing circuit. The storage unit includes a weight matrix. The control circuit re-orders an arrangement order of weights in the weight matrix according to a shape of an output matrix to determine a weight readout order of the weights. The computing circuit receives the weights based on the weight readout order, and performs a matrix computation on the weights and an input matrix to generate a computing matrix. The control circuit performs a reshape transformation on the computing matrix to generate the output matrix, and writes the output matrix to the storage unit.

### CROSS-REFERENCE TO RELATED APPLICATION

This application claims the priority benefit of Taiwan application serial no. 111139781, filed on Oct. 20, 2022. The entirety of the above-mentioned patent application is hereby incorporated by reference herein and made a part of this specification.

### BACKGROUND

### Technical Field

The disclosure relates to a computing device and an operation method for the computing device, and particularly relates to a matrix computing device and an operation method for the matrix computing device.

### Description of Related Art

FIG. 1 is a schematic diagram of a matrix multiplication computation. FIG. 1 shows a matrix MA and a matrix MB. The matrix MA is a matrix with M rows and K columns. The matrix MB is a matrix with K rows and N columns. Therefore, multiplying the matrix MA by the matrix MB produces a matrix MP with M rows and N columns.

It should be noted that a vector direction of the matrix MA and a vector direction of the matrix MB are different from each other based on the matrix multiplication. That is, a reading order of element values in the matrix MB is different from the reading order of element values in the matrix MA. Generally speaking, an arrangement order of element values of a matrix is to arrange element rows first. When a matrix computing device consumes the arrangement of an element row, the matrix computing device consumes the arrangement of a next element row. The reading order of element values of a matrix is to read element rows first. However, based on the matrix multiplication, the reading order of the element values of the matrix MB is to read element columns first. When the matrix computing device consumes the arrangement of an element column, the matrix computing device consumes the arrangement of a next element column.

The matrix computing device performs an additional transpose computation on the matrix MB by circuits or algorithms. Therefore, the cost of the matrix computing device increases.

### SUMMARY

The disclosure provides a matrix computing device and an operation method which can avoid transpose computations.

The matrix computing device according to an embodiment of the disclosure includes a storage unit, a control circuit, and a computing circuit. The storage unit includes a weight matrix. The control circuit is coupled to the storage unit. The control circuit re-orders an arrangement order of a plurality of weights in the weight matrix according to a shape of an output matrix to determine a weight readout order of the weights. The weight readout order is different from the arrangement order of the weights in the weight matrix. The computing circuit is coupled to the control circuit. The computing circuit receives the weights based on the weight readout order, and performs a matrix computation on the weights and an input matrix to generate a computing matrix. The control circuit performs a reshape transformation on the computing matrix to generate the output matrix, and writes the output matrix to the storage unit.

The operation method according to an embodiment of the disclosure is provided for a matrix computing device. The matrix computing device includes a storage unit and a computing circuit. The operation method includes: re-ordering an arrangement order of a plurality of weights in a weight matrix of the storage unit according to a shape of an output matrix to determine a weight readout order of the weights, and the weight readout order being different from the arrangement order of the weights in the weight matrix; receiving the weights based on the weight readout order by the computing circuit, and performing a matrix computation on the weights and an input matrix to generate a computing matrix; and performing a reshape transformation on the computing matrix to generate the output matrix, and writing the output matrix to the storage unit.

Based on the above, the matrix computing device and the operation method re-order the arrangement order of the weights in the weight matrix according to the shape of the output matrix to determine the weight readout order of the weights. The computing circuit performs the matrix computation on the weights and the input matrix based on the weight readout order to generate the computing matrix. It should be noted that the weight readout order changes the arrangement order of elements of the computing matrix. The arrangement order of the elements of the computing matrix helps achieve a transpose of a matrix when performing the reshape transformation. Therefore, the matrix computing device does not need to perform an additional transpose to achieve the transpose computation on the matrix. Therefore, the cost of the matrix computing device of the disclosure is not increased.

In order to make the above-mentioned features and advantages of the disclosure more comprehensible, the following embodiments are given and described in detail with the accompanying drawings as follows.

### BRIEF DESCRIPTION OF THE DRAWINGS

FIG. 1 is a schematic diagram of a matrix multiplication computation.

FIG. 2 is a schematic diagram of a matrix computing device according to an embodiment of the disclosure.

FIG. 3 is a schematic diagram of a matrix computation according to an embodiment of the disclosure.

FIG. 4A is a schematic diagram of a simple example of a current matrix computation.

FIG. 4B is a schematic diagram of a simple example of a matrix computation according to an embodiment of the disclosure.

FIG. 5 is a schematic circuit diagram of a computing circuit according to an embodiment of the disclosure.

FIG. 6 is a schematic diagram of an operation method according to an embodiment of the disclosure.

### DESCRIPTION OF THE EMBODIMENTS

Some embodiments of the disclosure will be described in detail below with reference to the accompanying drawings. Reference numerals quoted in the following description will be regarded as the same or similar components when the same reference numerals appear in different drawings. The embodiments are merely a part of the disclosure and do not disclose all possible implementations of the disclosure. More specifically, the embodiments are only examples within the scope of the claims.

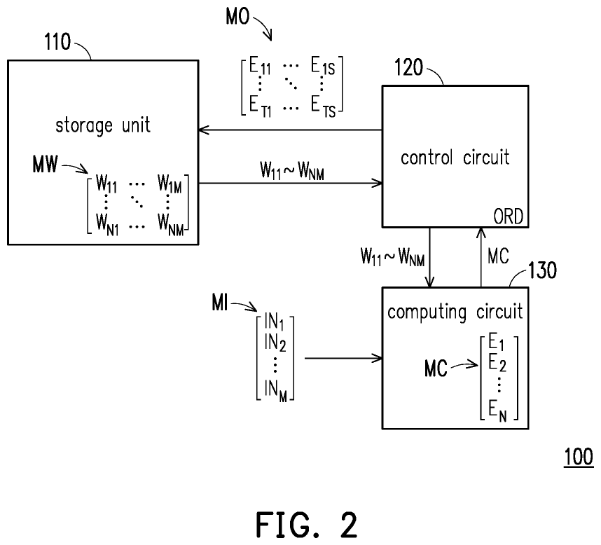

Please refer to FIG. 2. FIG. 2 is a schematic diagram of a matrix computing device according to an embodiment of the disclosure. In the embodiment, a matrix computing device 100 includes a storage unit 110, a control circuit 120 and a computing circuit 130. The storage unit 110 includes a weight matrix MW. In the embodiment, the weight matrix MW is, for example, a two-dimensional matrix with N rows and M columns (the disclosure is not limited thereto). The weight matrix MW includes weights W₁₁˜W_{NM}. In the embodiment, the storage unit 110 may be implemented by a memory component well known to those skilled in the art.

In the embodiment, the control circuit 120 is coupled to the storage unit 110. The control circuit 120 re-orders an arrangement order of the weights W₁₁˜W_{NM} according to a shape of an output matrix MO to determine a weight readout order ORD of the weights W₁₁˜W_{NM}. The output matrix MO is, for example, a two-dimensional matrix with T rows and S columns (the disclosure is not limited thereto). In the embodiment, S and T are positive integers greater than 1, respectively.

In the embodiment, when the weights W₁₁˜W_{NM} are written to the storage unit 110, the weights W₁₁˜W_{NM} are written in a row major first. That is, the weights W₁₁˜W_{1M} are sequentially written to a first row of the weight matrix MW. Next, the weights W₂₁˜W_{2M} are sequentially written to a second row of the weight matrix MW, and so on. Therefore, in a direction of the weight matrix MW, the weights W₁₁˜W_{1M}, the weights W₂₁˜W_{2M}, . . . , and the weights W_{N1}˜W_{NM} are arranged sequentially. Through re-ordering, the weight readout order ORD of the weights W₁₁˜W_{NM} is different from the arrangement order of the weights W₁₁˜W_{NM} in the weight matrix MW. For example, the control circuit 120 may read out the weights W₁₁˜W_{1M} first, then read out the weights W₃₁˜W_{3M}, and then read out the weights W₂₁˜W_{2M} based on the weight readout order ORD.

In the embodiment, the computing circuit 130 is coupled to the control circuit 120. The computing circuit 130 receives the weights W₁˜W_{NM} based on the weight readout order ORD. Therefore, a row order of the weights W₁₁˜W_{NM} received by the computing circuit 130 is different from the row order of the weights W₁₁˜W_{NM} in the weight matrix MW. The computing circuit 130 also receives an input matrix MI, and performs a matrix computation on the weights W₁₁˜W_{NM} and the input matrix MI to generate a computing matrix MC. In the embodiment, the input matrix MI is, for example, a one-dimensional matrix having M rows and 1 column (the disclosure is not limited thereto). Therefore, the input matrix MI includes input element values IN₁˜IN_{M}. The computing circuit 130 performs a matrix multiplication computation on the weights W₁₁˜W_{NM} and the input matrix MI to generate the computing matrix MC. Therefore, the computing matrix MC is a one-dimensional matrix with N rows and 1 column (the disclosure is not limited thereto). The computing matrix MC includes computing element values E₁˜E_{N}.

The control circuit 120 performs a reshape transformation on the computing matrix MC to generate the output matrix MO. The control circuit 120 writes the output matrix MO to the storage unit 110. The control circuit 120 increases a dimension of the computing matrix MC to generate the output matrix MO. In the embodiment, the control circuit 120 converts the dimension of the computing matrix MC from one-dimensional to two-dimensional, thereby generating the output matrix MO. For example, the control circuit 120 reads out the computing element values E₁˜E_{N} sequentially, and writes the computing element values E₁˜E_{N} to the output matrix MO in a row major first. Therefore, the matrix MO includes the computing element values E₁₁˜E_{TS}. It should be understood that the computing element value E₁₁ is equal to E₁. The computing element value E_{TS} is equal to E_{N}.

It is worth mentioning that the control circuit 120 re-orders the arrangement order of the weights W₁₁˜W_{NM} in the weight matrix MW according to the shape of the output matrix MO to determine the weight readout order ORD of the weights W₁₁˜W_{NM}. The computing circuit 130 performs the matrix computation on the weights W₁₁˜W_{NM} and the input matrix MI based on the weight readout order ORD to generate the computing matrix MC. It should be noted that the weight readout order ORD changes the arrangement order of the computing element values E₁˜E_{N} of the computing matrix MC. The arrangement order of the computing element values E₁˜E_{N} helps achieve a transpose of a matrix when performing the reshape transformation. In this way, the matrix computing device 100 does not need to perform an additional transpose to achieve a transpose computation on the computing matrix MC or the output matrix MO. The cost of the matrix computing device 100 is not increased.

In the embodiment, the control circuit 120 may be implemented by a logic circuit, a memory controller, an input/output (I/O) buffer, or a central processing unit (CPU). In the embodiment, the computing circuit 130 may be applicable to the matrix computation of a neural network (NN).

In some embodiments, the input matrix MI may be provided by an external device. In some embodiments, the input matrix MI may be provided by the storage unit 110.

For the convenience of explanation, the weight matrix MW is exemplified as a two-dimensional array. The input matrix MI is exemplified by a one-dimensional array. However, the disclosure is not limited thereto. In some embodiments, the weight matrix MW may be a one-dimensional array of multiple rows and one column. The input matrix MI may be a two-dimensional array.

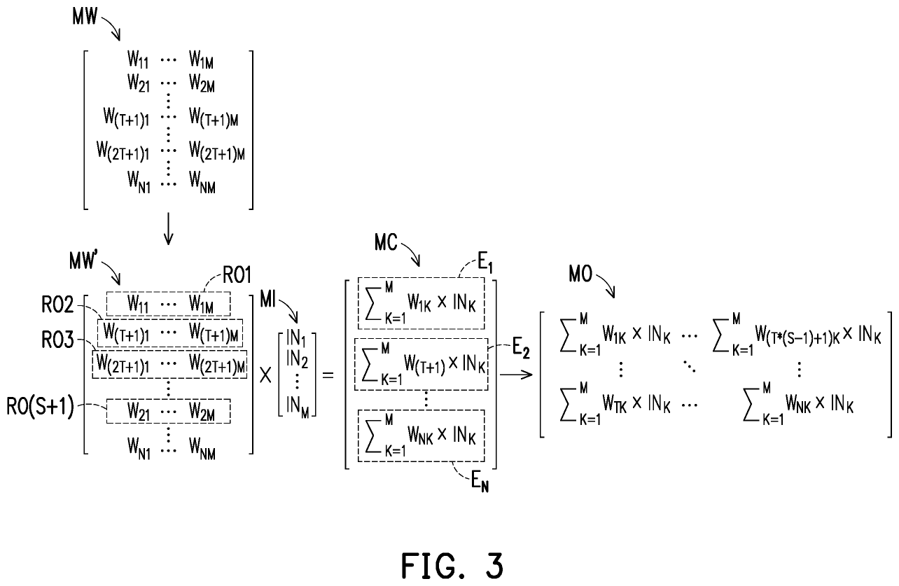

Please refer to FIG. 2 and FIG. 3 at the same time. FIG. 3 is a schematic diagram of a matrix computing device according to an embodiment of the disclosure. In the embodiment, the weight matrix MW includes a plurality of weight rows. A first weight row includes the weights W₁₁˜W_{1M}. A second weight row includes the weights W₂₁˜W_{2M}. A (T+1)th weight row includes the weights W_{(T+1)1}˜W_{(T+1)M}. A (2T+1)th weight row includes the weights W_{(2T+1)1}˜W_{(2T+1)M}. Similarly, it can be inferred that the Nth weight row includes the weights W_{N1}˜W_{NM}. The control circuit 120 determines the weight readout order ORD of the weights W₁₁˜W_{NM} in an order of interleave according to the number of rows and the number of columns of the output matrix MO.

In the embodiment, the output matrix MO is, for example, a two-dimensional matrix having T rows and S columns. The control circuit 120 takes a first weight row of the weight matrix MW as a first readout row RO1, and takes an (nT+1)th weight row of the weight matrix MW as an (n+1)th readout column RO(n+1). n is smaller than S. The control circuit 120 takes a second weight row of the weight matrix MW as an (S+1)th readout row RO(S+1), and takes an (nT+2)th weight row of the weight matrix MW as an (S+n+1)th readout row (not shown). Therefore, a readout matrix MW′ generated based on the weight readout order ORD is formed. In other words, the control circuit 120 converts the weight matrix MW to the readout matrix MW′ according to the weight readout order ORD. The first readout row RO1 includes the weights W₁₁˜W_{1M}. A second readout row RO2 includes the weights W_{(T+1)1}˜W_{(T+1)M} (i.e., n=1). A third readout row RO3 includes the weights W_{(2T+1)1}˜W_{(2T+1)M} (i.e., n=2). The (S+1)th readout row RO(S+1) includes the weights W₂₁˜W_{2M}.

An arrangement of the weights W₁₁˜W_{NM} received by the computing circuit 130 based on the weight readout order ORD is equivalent to an aspect of the readout matrix MW′. The computing circuit 130 performs the multiplication computation on the readout matrix MW′ and the input matrix MI to generate the computing matrix MC. The computing element value E₁ is equal to a multiply-accumulate (MAC) value of the weights W₁₁˜W_{1M} of the first readout row RO1 and the input element values IN₁˜IN_{M}. The computing element value E₂ is equal to the MAC value of the weights W₂₁˜W_{2M} of the second readout row RO2 and the input element values IN₁˜IN_{M}, and so on. The computing element values E₁ and E₂ are shown in formula (1) and formula (2) respectively as follows.

E₁=Σ_{K=1}^{M}W_{1K}×IN_{K} Formula (1)

E₂=Σ_{K=1}^{M}W_{2K}×IN_{K} Formula (2)

The control circuit 120 receives the computing matrix MC and converts the dimension of the computing matrix MC from one-dimensional to two-dimensional to generate the output matrix MO. It should be noted that the weight readout order ORD changes the arrangement order of the computing element values E₁˜E_{N} of the computing matrix MC. The arrangement order of the computing element values E₁˜E_{N} helps achieve the transpose of a matrix when performing the reshape transformation.

In some embodiments, the control circuit 120 stores the readout matrix MW′ to the storage unit 110. Therefore, in a case where the weights W₁₁˜W_{NM} are not updated, the control circuit 120 can read the readout matrix MW′ without performing a re-ordering operation. In some embodiments, the readout matrix MW′ and the weight matrix MW are respectively stored in different segments of the storage unit 110. In some embodiments, when the readout matrix MW′ is stored in the storage unit 110, the readout matrix MW′ covers the weight matrix MW.

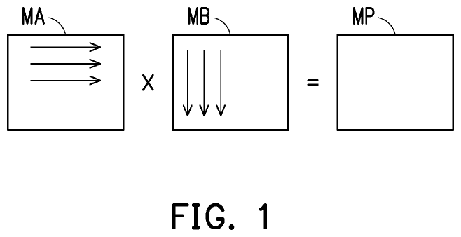

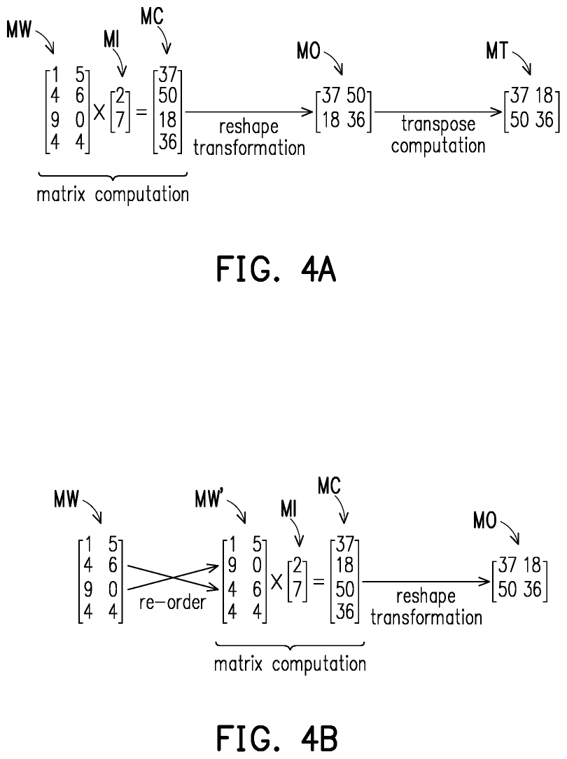

For example, please refer to FIG. 4A and FIG. 4B at the same time. FIG. 4A is a schematic diagram of a simple example of a current matrix computation. FIG. 4B is a schematic diagram of a simple example of a matrix computation according to an embodiment of the disclosure. FIG. 4A shows how the output matrix MO is generated. In the current matrix computation, the weight matrix MW is performed a multiplication computation by the input matrix MI to generate the computing matrix MC. Therefore, the computing element values of the computing matrix MC are sequentially “37”, “50”, “18”, and “36”. After a reshape transformation, the computing element values of the output matrix MO are also sequentially “37”, “50”, “18”, and “36”. It should be noted that when the output matrix MO is used as the matrix MB as shown in FIG. 1, the output matrix MO must be transformed to form a transposed matrix MT through a transpose computation, so that the arrangement of the computing element values is changed to “37”, “18”, “50”, and “36”. The output element values of the output matrix MO depend on input element values. In this case, the input element values are the variables such as activations in NN from precious layer that receives during operation. Therefore, the transpose computation of the output matrix MO is an additional matrix computation. Therefore, a computational cost is increased.

FIG. 4B shows how the output matrix MO of the embodiment is generated. In the embodiment, the weight matrix MW is first re-ordered to generate the readout matrix MW′. It should be noted that in NN applications, weights are parameters rather than variables. Therefore, the re-ordering of the weight matrix MW can be done in an offline state. The re-ordering of the weight matrix MW is not performed in an NN operation. That is to say, the generation of the readout matrix MW′ does not increase the computational cost or power consumption during the operation of NN. The readout matrix MW′ is performed a multiplication computation by the input matrix MI to generate the computing matrix MC. Therefore, the computing element values of the computing matrix MC are sequentially “37”, “18”, “50”, and “36”. After a reshape transformation, the computing element values of the output matrix MO are also sequentially “37”, “18”, “50”, and “36”. The output matrix MO shown in FIG. 4B is equal to the transposed matrix MT shown in FIG. 4A. That is to say, in the embodiment, the re-ordering of the weight matrix MW can be added to realize the output of the transpose computation result of the output matrix MO as shown in FIG. 4A.

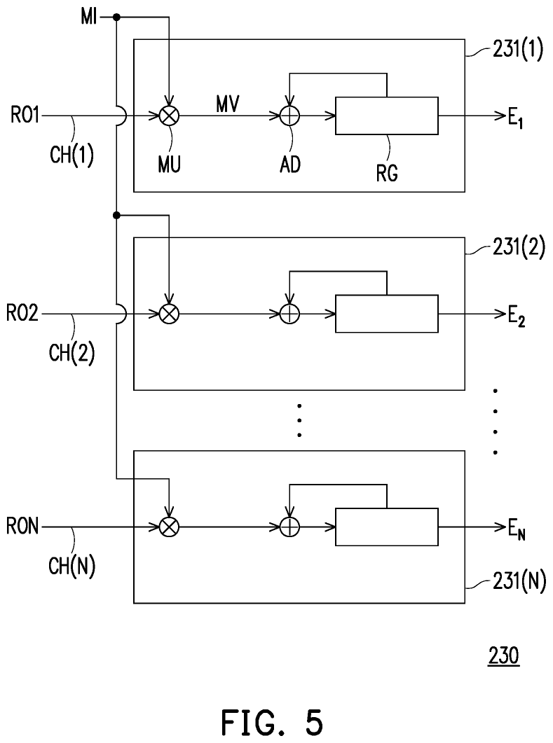

Please refer to FIG. 2, FIG. 3 and FIG. 5 at the same time. FIG. 5 is a schematic circuit diagram of a computing circuit according to an embodiment of the disclosure. In the embodiment, the computing circuit 230 includes MAC circuits 231(1)˜231(N). The MAC circuits 231(1)˜231(N) are respectively coupled to the control circuit 120 through different channels. The MAC circuits 231(1)˜231(N) respectively receive the corresponding weight rows of the weight matrix MW through different channels. The MAC circuit 231(1) is coupled to the control circuit 120 through a channel CH(1). The MAC circuit 231(2) is coupled to the control circuit 120 through a channel CH(2). Similarly, the MAC circuit 231(N) is coupled to the control circuit 120 through a channel CH(N).

Taking the embodiment as an example, the MAC circuit 231(1) receives a corresponding weight row (i.e., the first readout row RO1) through the channel CH(1). Therefore, the MAC circuit 231(1) receives the weights W₁₁˜W_{1M} sequentially through the channel CH(1), and performs a MAC computation on the weights W₁₁˜W_{1M} and the input matrix MI to generate the computing element value E₁ of the computing matrix MC. The MAC circuit 231(2) receives the corresponding weight row (i.e., the second readout row RO2) through the channel CH(2). Therefore, the MAC circuit 231(2) receives the weights W_{(T+1)1}˜W_{(T+1)M} sequentially through the channel CH(2), and performs the MAC computation on the weights W_{(T+1)1}˜W_{(T+1)M} and the input matrix MI to generate the computing element value E₂ of the computing matrix MC. Similarly, the MAC circuit 231(N) receives the weights W_{N1}˜W_{NM} of the N-th readout row RON through the channel CH(N), and performs the MAC computation on the weights W_{N1}˜W_{NM} and the input matrix MI to generate the computing element value E_{N} of the computing matrix MC.

Taking the MAC circuit 231(1) as an example, the MAC circuit 231(1) includes a multiplier MU, a register RG, and an adder AD. The register RG stores the computing element value E₁ at a first time. At this time, the computing element value E₁ may be an initial value (e.g., “0”). The multiplier MU is coupled to the channel CH(1) and the input matrix MI. The multiplier MU receives the weight W₁₁ and input data IN₁ in the input matrix MI at the first time, and performs the multiplication computation on the weight W₁₁ and the input data IN₁ to generate a product value MV. The adder AD receives the computing element value E₁ stored in the register RG and the product value MV from the multiplier MU at the first time. The adder AD performs an addition computation on the computing element value E₁ and the product value MV to generate a new computing element value E₁, and stores the new computing element value E₁ in the register RG. At a second time, the multiplier MU receives the weight W₁₂ and the input data IN₂ in the input matrix MI, and performs a multiplication computation on the weight W₁₂ and the input data IN₂ to generate a new product value MV. The adder AD receives the new product value MV and the computing element value E₁ stored in the register RG at the first time. The adder AD performs an addition computation on the computing element value E₁ and the new product value MV to generate another new computing element value E₁, and so on.

In the embodiment, the circuit configuration of the MAC circuits 231(2)˜231(N) is similar to the circuit configuration of the MAC circuit 231(1), and will not be repeated here.

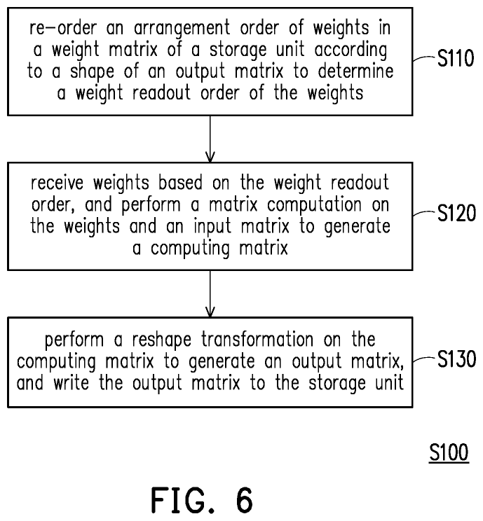

Please refer to FIG. 2 and FIG. 6 at the same time. FIG. 6 is a schematic diagram of an operation method according to an embodiment of the disclosure. The operation method S100 is applicable to the matrix computing device 100. The operation method S100 includes steps S110 to S130. In step S110, the control circuit 120 re-orders the arrangement order of the weights W₁₁˜W_{NM} in the weight matrix MW of the storage unit 110 according to the shape of the output matrix MO to determine the weight readout order ORD of the weights W₁₁˜W_{NM}.

In step S120, the computing circuit 130 receives the weights W₁₁˜W_{NM} based on the weight readout order ORD, and performs a matrix computation on the weights W₁₁˜W_{NM} and the input matrix MI to generate a computing matrix MC.

In step S130, the control circuit 120 performs the reshape transformation on the computing matrix MC to generate an output matrix MO, and writes the output matrix MO to the storage unit 110. The implementation details of steps S110 to S130 have been described in the embodiments of FIG. 1 to FIG. 5, and will not be repeated here.

To sum up, the matrix computing device and the operation method re-order the arrangement order of the weights in the weight matrix according to the shape of the output matrix to determine the weight readout order of the weights. The computing circuit performs the matrix computation on the weights and the input matrix based on the weight readout order to generate the computing matrix. The weight readout order changes the element arrangement order of the computing matrix. The element arrangement order of the computing matrix helps achieve the transpose of a matrix when performing the reshape transformation. Therefore, the matrix computing device does not need to perform an additional transpose to achieve the transpose computation on the matrix. The cost of the matrix computing device of the disclosure is not increased.

Although the disclosure has been disclosed with reference to the embodiments above, they are not intended to limit the disclosure. Anyone with ordinary knowledge in the technical field can make some changes and modifications without departing from the spirit and scope of the disclosure. Therefore, the protection scope of the disclosure shall be determined by the appended claims.

What is claimed is:

1. A matrix computing device, comprising:
a storage unit which comprises a weight matrix;
a control circuit which is coupled to the storage unit and configured to re-order an arrangement order of a plurality of weights in the weight matrix according to a shape of an output matrix to determine a weight readout order of the weights, wherein the weight readout order is different from the arrangement order; and
a computing circuit which is coupled to the control circuit and configured to receive the weights based on the weight readout order, and to perform a matrix computation on the weights and an input matrix to generate a computing matrix, wherein
the control circuit performs a reshape transformation on the computing matrix to generate the output matrix, and writes the output matrix to the storage unit.

2. The matrix computing device according to claim 1, wherein the control circuit determines the weight readout order of the weights in an order of interleave according to the number of rows and the number of columns of the output matrix.

3. The matrix computing device according to claim 2, wherein,
the output matrix is a two-dimensional matrix with T rows and S columns, where S and T are positive integers greater than 1, respectively;
the control circuit takes a first weight row of the weight matrix as a first readout row, and takes an (nT+1)th weight row of the weight matrix as an (n+1)th row, wherein n is smaller than S; and
the control circuit takes a second weight row of the weight matrix as an (S+1)th row, and takes an (nT+2)th weight row of the weight matrix as an (S+n+1)th row.

4. The matrix computing device according to claim 1, wherein the computing circuit comprises:
a plurality of multiply-accumulate (MAC) circuits which are respectively coupled to the control circuit through different corresponding channels and are respectively configured to receive the weights of corresponding weight rows of the weight matrix through the corresponding channels.

5. The matrix computing device according to claim 4, wherein a first MAC circuit of the MAC circuits receives a first weight row and the input matrix through a first channel, and performs a MAC computation on the first weight row and the input matrix to generate a first computing element value of the computing matrix.

6. The matrix computing device according to claim 4, wherein each of the plurality of MAC circuits comprises:
a multiplier which is coupled to the corresponding channel and the input matrix, and is configured to receive a first weight of the corresponding weight row and first input data of the input matrix at a first time, and to perform a multiplication computation on the first weight and the first input data to generate a product value;
a register configured to store a computing element value at the first time; and
an adder which is coupled to the multiplier and the register, and is configured to receive the computing element value stored in the register and the product value from the multiplier at the first time, perform an addition computation on the computing element value and the product value to generate a new computing element value, and store the new computing element value in the register.

7. The matrix computing device according to claim 1, wherein the control circuit increases a dimension of the computing matrix to generate the output matrix.

8. The matrix computing device according to claim 1, wherein the control circuit converts the weight matrix to a readout matrix according to the weight readout order, and stores the readout matrix in the storage unit.

9. An operation method for a matrix computing device, wherein the matrix computing device comprises a storage unit and a computing circuit, the operation method comprising:
re-ordering an arrangement order of a plurality of weights in a weight matrix of the storage unit according to a shape of an output matrix to determine a weight readout order of the weights, wherein the weight readout order is different from the arrangement order;
receiving the weights by the computing circuit based on the weight readout order, and performing a matrix computation on the weights and an input matrix to generate a computing matrix; and
performing a reshape transformation on the computing matrix to generate the output matrix, and writing the output matrix to the storage unit.

10. The operation method according to claim 9, wherein re-ordering the arrangement order of the weights in the weight matrix of the storage unit according to the shape of the output matrix to determine the weight readout order of the weights comprises:
determining the weight readout order of the weights in an order of interleave according to the number of rows and the number of columns of the output matrix.

11. The operation method according to claim 10, wherein the output matrix is a two-dimensional matrix with T rows and S columns, where S and T are positive integers greater than 1, respectively, wherein re-ordering the arrangement order of the weights in the weight matrix of the storage unit according to the shape of the output matrix to determine the weight readout order of the weights comprises:
taking a first weight row of the weight matrix as a first readout row;
taking an (nT+1)th weight row of the weight matrix as an (n+1)th row, wherein n is smaller than S;
taking a second weight row of the weight matrix as an (S+1)th row; and
taking an (nT+2)th weight row of the weight matrix as an (S+n+1)th row.

12. The operation method according to claim 10, wherein the computing circuit comprises a plurality of MAC circuits, and the operation method further comprises:
receiving the weights of corresponding weight rows of the weight matrix respectively by the plurality of MAC circuits through different corresponding channels.

13. The operation method according to claim 12, wherein the output matrix is a two-dimensional matrix with T rows and S columns, where S and T are positive integers greater than 1, respectively, wherein receiving the weights of the corresponding weight rows of the weight matrix respectively by the plurality of MAC circuits through the different corresponding channels comprises:
receiving a first weight row and the input matrix through a first channel by a first MAC circuit of the plurality of MAC circuits; and
performing a MAC computation on the first weight row and the input matrix by the first MAC circuit to generate a first computing element value of the computing matrix.

14. The operation method according to claim 12, wherein the plurality of MAC circuits each comprises a multiplier, a register, and an adder, wherein receiving the weights of the corresponding weight rows of the weight matrix respectively by the plurality of MAC circuits through different corresponding channels comprises:
receiving a first weight of the corresponding weight row and first input data of the input matrix by the multiplier at a first time, and performing a multiplication computation on the first weight and the first input data to generate a product value;
storing a computing element value at the first time by the register; and
receiving the computing element value stored in the register and the product value from the multiplier at the first time by the adder, performing an addition computation on the computing element value and the product value to generate a new computing element value, and storing the new computing element value in the register.

15. The operation method according to claim 10, wherein performing the reshape transformation on the computing matrix to generate the output matrix comprises:
increasing a dimension of the computing matrix to generate the output matrix.

16. The operation method according to claim 9, further comprising:
converting the weight matrix to a readout matrix according to the weight readout order, and storing the readout matrix in the storage unit.
